(19) United States
(12) Patent Application Publication
(10) Pub. No.: US 2006/0090327 A1
(43) Pub. Date: May 4, 2006

(54) Carrier ring comprising a plurality of springs

(76) Inventor: Eric Daniel Jeronne Garcia, Jalisco (MX)

Correspondence Address: WAGNER, MURABITO & HAO LLP, Third Floor, Two North Market Street, San Jose, CA, 95113, US

(21) Appl. No.: 10/977,606

(22) Filed: Oct. 29, 2004

(51) Int. Cl. B23Q 7/00; B25B 27/14

(52) U.S. Cl. 29/559; 29/281.1; 29/281.4

(57) ABSTRACT

Embodiments of the present invention include an apparatus for handling a work piece. The apparatus comprises a rigid frame having an interior perimeter and an exterior perimeter, wherein the interior perimeter comprises a plurality of mounts. The apparatus further includes a plurality of retention springs coupled to the plurality of mounts, the retention springs for applying a retention force on the work piece to prevent movement between the work piece and the interior perimeter of the rigid frame. The apparatus further includes an actuating mechanism for simultaneously actuating each of the plurality of retention springs from an open position to a closed position.

### FIELD OF THE INVENTION

The present invention relates to the manufacture and handling of magnetic read/write work pieces. More specifically, embodiments of the present invention relate to an improved work piece carrier ring for reducing contamination of the work pieces.

### BACKGROUND OF THE INVENTION

Conventionally, a data access and storage system comprises one or more storage devices that store data on a magnetic or optical storage media. One example of a magnetic storage device is a hard disk drive. Another example of a magnetic storage device is a direct access storage device. Each of these devices can comprise one or more disks and a disk controller to manage operations on each of the disks.

Typically, each side of each disk of the storage device has a dedicated read/write head that scans the disk during a read or write operation. The read/write head hovers above the disk as the disk spins underneath. Many times the read/write head is attached to an arm that allows the head to move to locate a desired track on the disk.

Conventionally, the read/write heads or sliders are fabricated from a small substrate or work piece. The work pieces are manufactured and handled in a fixture called a carrier. The carrier is used to handle and transport the delicate work pieces with minimal physical contact.

In some cases, the carrier allows movement between the work piece and the carrier. As a result, microscopic flaking of the work piece occurs where the work piece contacts the carrier and in some cases, the flakes contaminate the work piece.

Contaminates of the work piece interfere with the operation of the magnetic storage deice during read and write operations. Many times, the contaminates render the device useless. As such, an improved carrier is needed that reduces movement of the work piece within the carrier.

### SUMMARY OF THE INVENTION

Embodiments of the present invention include an apparatus for handling a work piece. The apparatus comprises a rigid frame having an interior perimeter and an exterior perimeter, wherein the interior perimeter comprises a plurality of mounts. The apparatus further includes a plurality of retention springs coupled to the plurality of mounts, the retention springs for applying a retention force on the work piece to prevent movement between the work piece and the interior perimeter of the rigid frame. The apparatus further includes an actuating mechanism for simultaneously actuating each of the plurality of retention springs from an open position to a closed position.

### BRIEF DESCRIPTION OF THE DRAWINGS

The above and other objects and advantages of the present invention will be more readily appreciated from the following detailed description when read in conjunction with the accompanying drawings, wherein:

FIG. 1 is a diagram of an exemplary rigid frame assembly comprising a plurality of retention springs in accordance with embodiments of the present invention.

FIG. 2 is a top view of an exemplary rigid frame with a work piece secured within the interior perimeter of the rigid frame in accordance with embodiments of the present invention.

FIG. 3 is a diagram of an exemplary retention spring in accordance with embodiments of the present invention.

FIG. 4 is a diagram of an exemplary fixture comprising a retention spring actuator in accordance with embodiments of the present invention.

FIG. 5 is a flow diagram of an exemplary process for handling a work piece in accordance with embodiments of the present invention.

### DETAILED DESCRIPTION OF THE INVENTION

Reference will now be made in detail to embodiments of the present invention, a system and method for striping data, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims.

Furthermore, in the following detailed description of the present invention, numerous specific details are set forth in order to provide a thorough understanding of the present invention. However, it will be recognized by one of ordinary skill in the art that the present invention may be practiced without these specific details. In other instances, well known methods, procedures, components, and circuits have not been described in detail as not to unnecessarily obscure aspects of the present invention.

Embodiments of the present invention include a carrier ring for handling delicate work pieces. In one embodiment of the invention, the carrier ring is used to handle work pieces associated with manufacture of a magnetic data storage device. More specifically, embodiments of the present invention include a carrier ring for handling a substrate used to manufacture a slider of a magnetic data storage device.

The carrier ring of the present invention prevents movement of the work piece during processing and in one embodiment of the invention, reduces flaking of a liquid photo resist that is applied to the work piece. Reducing flaking of photo resist on the work piece improves overall quality of the work piece and allows the carrier ring to be used in manufacture processes that conventional carrier rings could not be used. Flaking of the photo resist can cause unwanted scratching and contamination of the work piece. The carrier ring of the present invention reduces movement of the work piece during manufacture and reduces the chances for contamination from flakes of photo resist. The carrier ring of the present invention greatly improves quality and reduces processing times for the work pieces.

Embodiments of the present invention include a carrier ring that reduces contamination during handling and during manufacture of a work piece. The carrier ring of the present invention provides a retention force capable of preventing movement between the work piece and the carrier, thus reducing flaking of photo resist, scratching and contamination of the work piece. As an added benefit of the present invention, the improved carrier ring can be used in manufacture processes that a conventional carrier ring could not be used.

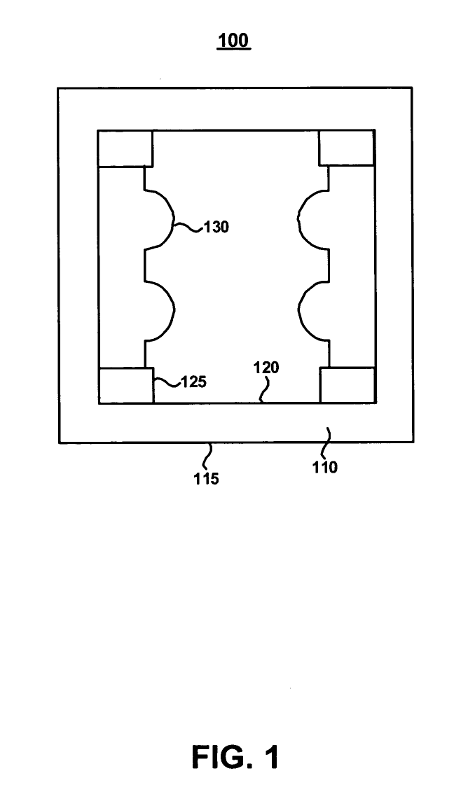

FIG. 1 is an illustration of an exemplary apparatus 100 for handling a work piece. Apparatus 100 comprises an exemplary rigid frame 110 (e.g., carrier ring). The rigid frame 110 comprises an interior perimeter 120 and an outer perimeter 115. In one embodiment of the invention, the rigid frame comprises four orthogonal sides. In this embodiment of the invention, the rigid frame 110 is substantially square or rectangular in shape. The dimensions of the rigid frame 110 can be any size that is larger than an individual work piece.

In one embodiment of the invention, the carrier ring is used to secure a work piece during deposition of a photo resist. In one embodiment of the invention, the carrier ring is used to secure a work piece during deposition of a liquid photo resist. In this embodiment of the invention, the rigid frame 110 comprises stainless steel to reduce corrosion of the apparatus 100. Although embodiments of the present invention include a carrier ring made from stainless steel, the carrier ring can be made from any material suitable for specific applications. For example, the carrier ring could also be made from Aluminum or Titanium.

The rigid frame 110 comprises spring mounts 125 that are used to fix retention springs 130 to the rigid frame 110. In one embodiment of the invention, the rigid frame comprises two retention springs. In this embodiment the retention springs are positioned parallel with respect to two sides of the rigid frame 110. In one embodiment of the invention, the spring mounts 125 comprise a setscrew that secures the retention spring 130 to the spring mount 125.

In one embodiment of the invention, the spring mount is coupled to an actuating mechanism that moves the retention springs from an open position to a closed position. In the open position, the work piece can be positioned between the retention springs and in the closed position, the retention springs apply a retention force on the work piece that prevents movement of the work piece in the carrier ring.

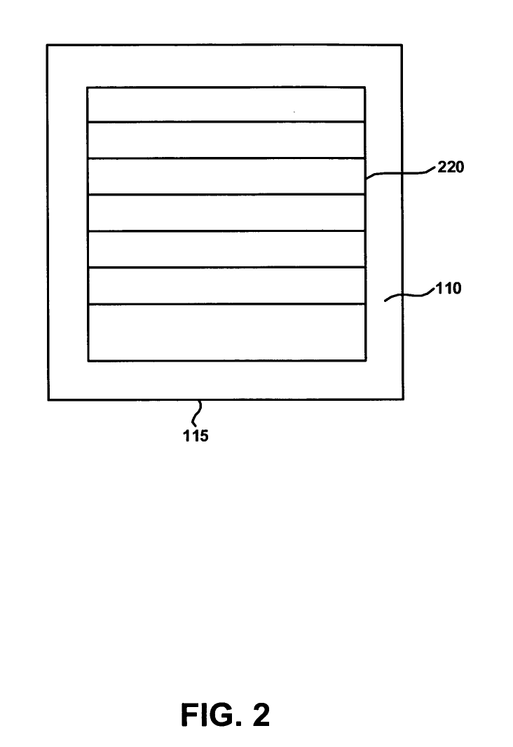

FIG. 2 is an illustration of an exemplary carrier ring 110 with a work piece 220 (e.g., carrier substrate) positioned within the interior perimeter of the carrier ring 110. The work piece may comprise any number of objects, however, in one embodiment of the invention, the work piece 220 is a read/write head slider of a magnetic storage device. In one embodiment of the invention, the carrier ring 110 is used to handle the work piece 220 during photolithography.

During photolithography, a photo resist is applied to the work piece. It is important to prevent movement of the work piece during photolithography because movement can cause the photo resist to flake off of the work piece. The flakes can scratch the surface finish of the work piece, thus damaging the work piece. The flakes can also cause contamination of the photolithography equipment and machinery used for subsequent processing. The carrier ring of the present invention can be used during deposition of a liquid or dry photo resist.

In one embodiment of the invention, the top of the work piece 220 is flush with the topside of the carrier ring 220. The work piece 220 is secured within the carrier ring 110 by the retention springs 130 of FIG. 1. The retention springs 130 of FIG. 1 prevent movement of the work piece 220 within the rigid frame 110. By preventing movement of the work piece, flaking of photo resist is reduced and contamination of the work piece is also reduced.

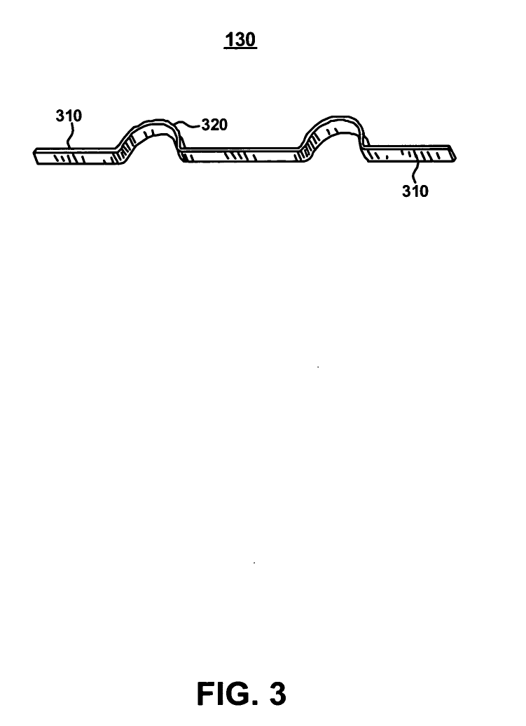

FIG. 3 is an illustration of an exemplary retention spring 130 in accordance with embodiments of the present invention. The retention spring 130 comprises mounting ends 130 that are configured to couple to the spring mounts 125 of FIG. 1. In one embodiment of the invention, the retention spring 130 is a leaf spring. In another embodiment of the invention, the retention spring comprises bends 320. The bends 320 are configured such that the retention spring 130 contacts a work piece on a plurality of contact points.

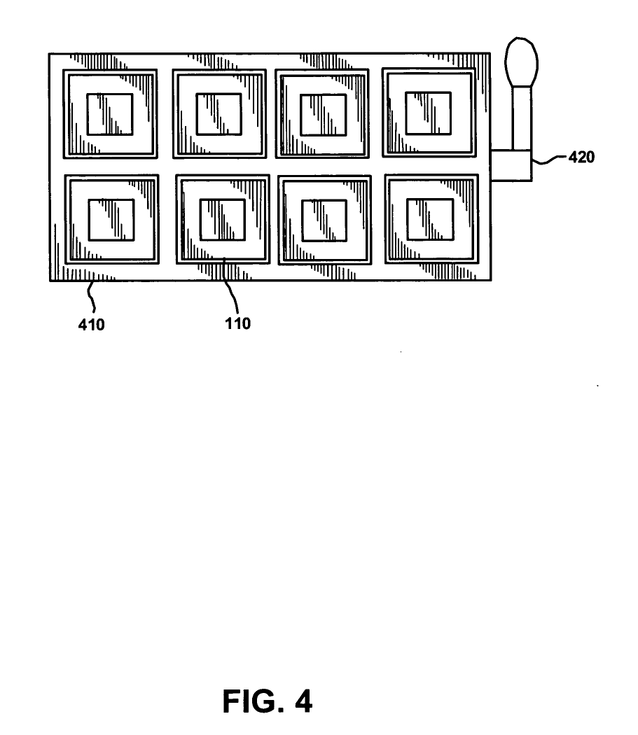

FIG. 4 is an illustration of an exemplary fixture 410 in accordance with embodiments of the present invention. Fixture 410 is configured to receive a plurality of carrier rings 110. In one embodiment of the invention, the fixture 410 can receive eight carrier rings 110. In one embodiment of the invention, the carrier comprises an engagement lever 420. In one embodiment of the invention, the engagement lever 420 can simultaneously actuate each of the retention springs 130 (of FIG. 1) of all of the carrier rings in the fixture. In the case of eight carrier rings 110 in the fixture 410, sixteen retention springs 130 can be simultaneously actuated with the engagement lever 420.

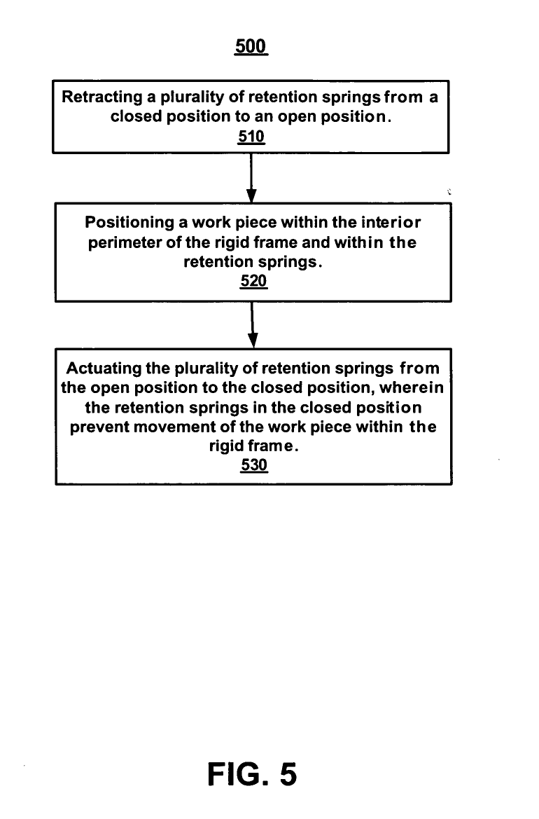

FIG. 5 is a flow diagram of an exemplary process 500 for handling work piece in accordance with embodiments of the present invention.

At step 510, embodiments of the present invention include retracting a plurality of retention springs from a closed position to an open position. In one embodiment of the invention, a carrier ring comprises two retention springs. In this embodiment of the invention, the retention springs of the carrier ring can be simultaneously retracted from a closed position to an open position by an actuating mechanism coupled to the carrier ring. In another embodiment of the invention, an engagement lever on a fixture is used to actuate the pair of retention springs. In this embodiment of the invention, a plurality of pairs of retention springs (on a plurality of carrier rings) can be simultaneously actuated.

At step 520, embodiments of the present invention include positioning a work piece within the interior perimeter of the rigid frame and within the open retention springs. In one embodiment of the invention, the top surface of the work piece is planar with the top surface of the rigid frame.

At step 530, embodiments of the present invention include actuating the plurality of retention springs from the open position to the closed position. When in the closed position, the retention springs prevent movement of the work piece within the rigid frame. In one embodiment of the invention, the retention springs contact the work piece on a plurality of contact points. In this embodiment of the invention, the retention force is applied equally over the plurality of contact points.

Embodiments of the present invention include a carrier ring comprising a plurality of retention springs. In one embodiment of the invention, two parallel leaf springs are used to retain a work piece in the carrier ring. The present invention reduces movement within the carrier ring and reduces damage and contamination of the work piece during manufacture and handling.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and it's practical application, to thereby enable others skilled in the art to best utilize the invention and various embodiments with various modifications as are suited to the particular use contemplated. It is intended that the scope of the invention be defined by the Claims appended hereto and their equivalents.

What is claimed is:

1. An apparatus for handling a work piece comprising:
a rigid frame comprising an interior perimeter and an exterior perimeter, said interior perimeter comprising a plurality of mounts;
a plurality of retention springs coupled to said plurality of mounts, said retention springs for applying a retention force on said work piece to prevent movement between said work piece and said interior perimeter of said rigid frame; and
an actuating mechanism for simultaneously actuating each of said plurality of retention springs from an open position to a closed position.

2. The apparatus as described in claim 1 wherein said rigid frame comprises four orthogonal sides.

3. The apparatus as described in claim 2 comprising two retention springs located on parallel sides of said frame.

4. The apparatus as described in claim 3 wherein each of said retention springs is configured to contact said work piece on a plurality contact points in said closed position.

5. The apparatus as described in claim 4 wherein said retention force is equally distributed over said plurality of contact points in said closed position.

6. The apparatus as described in claim 1 further comprising a fixture configured to receive said rigid frame and configured to couple to said actuating mechanism such that said plurality of retention springs are simultaneously actuated.

7. The apparatus as described in claim 1 wherein said plurality of retention springs prevent movement of said work piece during deposition of a liquid photo resist on said work piece.

8. The apparatus as described in claim 1 wherein said rigid frame comprises stainless steel.

9. The apparatus as described in claim 1 wherein said work piece comprises a slider for a magnetic data storage device.

10. A method for handling a work piece comprising:
retracting a plurality of retention springs from a closed position to an open position, said retention springs positioned on an interior perimeter of a rigid frame wherein a distance between said retention springs in said open position is larger than a dimension of said work piece;
positioning said work piece within said interior perimeter of said rigid frame and within said plurality of said retention springs; and
actuating said plurality of retention springs from said open position to said closed position, wherein said retention springs in said closed position prevent movement of said work piece within said rigid frame.

11. The method as described in claim 10 further comprising:
depositing a photo resist layer on said work piece.

12. The method as described in claim 10 further comprising:
depositing a liquid photo resist layer on said work piece.

13. The method as described in claim 10 further comprising:
positioning said rigid frame in a fixture, said fixture configured to simultaneously actuate said plurality of retention springs from said closed position to said open position.

14. The method as described in claim 13 further comprising:
positioning a plurality of rigid frames in said fixture wherein each of said plurality of rigid frames comprises a plurality of retention springs and wherein said fixture is configured to simultaneously actuate said plurality of springs of said plurality of rigid frames.

15. The method as described in claim 10 wherein said plurality of retention springs comprise two leaf springs.

16. A retention device for preventing movement of a work piece comprising:
a rigid frame comprising an interior perimeter and an exterior perimeter;
a plurality of retention springs coupled to interior perimeter, said retention springs for applying a retention force on said work piece to prevent movement between said work piece and said interior perimeter of said rigid frame; and
a spring actuator coupled to said plurality of retention springs and coupled to said rigid frame, said spring actuator configured to simultaneously actuate each of said plurality of retention springs from an open position to a closed position.

17. The retention device as described in claim 16 wherein said rigid frame comprises four orthogonal sides.

18. The retention device as described in claim 17 comprising two retention leaf springs located on parallel sides of said frame.

19. The retention device as described in claim 18 wherein each of said retention leaf springs is configured to contact said work piece on a plurality contact points while in said closed position.

20. The retention device as described in claim 19 wherein said retention force is equally distributed over said plurality of contact points in said closed position.

21. The retention device as described in claim 17 further comprising a fixture configured to receive said rigid frame and configured to couple to said actuating mechanism such that said plurality of retention springs are simultaneously actuated.

22. The retention device as described in claim 17 wherein said plurality of retention springs prevent movement of said work piece during deposition of a liquid photo resist on said work piece.

23. The retention device as described in claim 17 wherein said rigid frame comprises stainless steel.

24. The retention device as described in claim 17 wherein said work piece comprises a slider for a magnetic data storage device.
